(19) United States
(12) Patent Application Publication
(10) Pub. No.: US 2014/0373547 A1
(43) Pub. Date: Dec. 25, 2014

(54) Total synergetic integration of all eternal energies solar, atmosferic, wind, geo thermal, and universal fuel capability with maximum efficiency systems

(71) Applicant: Marius Angelo Paul, Yorba Linda, CA (US)

(72) Inventor: Marius Angelo Paul, Yorba Linda, CA (US)

(21) Appl. No.: 13/986,989

(22) Filed: Jun. 21, 2013

(51) Int. Cl. H02K 7/18

(52) U.S. Cl. CPC H02K 7/18
USPC 60/716

(57) ABSTRACT

Total Synergetic Integration of all eternal energy solar atmospheric, wind, geo thermal universal fuel capabilities with maximum absolute efficiency.

The invention relate to total and eternal energy efficiency system which capture, transfer, and convert directly in electric energy, all the eternal thermal atmospheric, wind energy, geo thermal energy, universal fuel capability, and integration of thermal and photo voltaic total solar energy with maximum absolute efficiency.

### BACKGROUND

The invention is a continuation in part and a derivative and functional alternative of the original invention: Universal Cross hyperbaric, hybrid, thermal electric engine, compressor, expander and universal mobility system, patent application Ser. No. 13/815,971, filling date Mar. 18, 2013, US PATENT CONFIRMATION NO. 2561/05/20/2013

Is very well known the low electric efficiency of the photovoltaic solar conventional systems, in which majority of solar energy is received by the solar panel, which is thermal energy unusable by the photo voltaic active surface.

The photovoltaic low efficiency is limited by active solar time and totally zero in nights and more reduced by cloudy covered skis.

The solar energy systems needs back up power for the time when is not productive by other sources of energy usually thermal, wind, or hydraulic additional power plants, finally making the wind and solar energy systems very expensive and long time for recovery of the initial investment.

### BRIEF DESCRIPTION OF THE INVENTION

Our invention is an eternal total combined and integrated thermal and photovoltaic solar and atmospheric wind and thermal energy systems, general geo thermal, with integrated universal fuel back up capability, and all thermal sources of available energy, associated in a general multiple synergetic system, with an integrated wind and a solar farm system, which is composed by a double panel active integrated systems in which over the thermal power panel face is applied the photovoltaic active foil in intimate contact surface to surface, forming a totally energetic system, with totally maximum efficiency.

Our general solar, wind and thermal farm industry is always back up by the alternative sources of energies independent of whether variable conditions without the danger of zero capability, situation solved by our universal cross hyperbaric thermal engine instantly capability to produce all the energy by replacing the lack of steam by universal combustion of any CNG, LNG, Hydrogen or any alternative fuel available.

An individual home provided with roof solar photo voltaic fixed panel, can be associated with a small universal cross hyperbaric engine electric generator for eternal support of electric urban distributed power system, using any available fuels in the urban area, producing energy and pure water with zero emission of pollutant gases.

This unique energetic capability is the guarantee of universal eternal applicability over the entire planet.

The photo voltaic electric energy is producing DC current proportionally with the intensity of the solar energy, and the thermal energy is absorbed by a refrigeration fluid cooling the thermal panel, transformed in high pressure steam which is conducted and converted in alternative electric AC current by a thermal electric steam cross hyperbaric engine with maximum absolute Carnot cycle near 100% efficiency.

The wind farm energy systems are also variable depending on whether condition, producing DC current capable to electrolyze the available water, ideally salt water of oceans, producing eternal generation of oxygen and hydrogen, ideal fuel, for combustion, and steam power by our universal cross hyperbaric thermal electric engine, and finally resulting eternal energy and pure water from salt water.

The steam cross hyperbaric engine is the basic fundamental direct transformer of any and all thermal energies in electric energy, which is the central main essential participant of this invention and producer of the total eternal energy systems, which can be associated in any place on the planet with geo thermal eternal energy source, universal fuel alternative3 capability, or any general thermal source available for recovery.

The double integrated thermal and solar panel is supported by a self oriented and articulated ground support position in permanent direction with maximum intensity solar energy.

How long the external atmospheric temperature is over the boiling temperature of the refrigeration fluid the total thermal energy system is producing highest efficient electric energy near 100% collecting eternal atmospheric heat, including nuclear energy.

This invention is the unique general and eternal direct transformer of all thermal sources of energies available on this planet in electric energy, for eternal prosperity of humanity.

### BRIEF DESCRIPTION OF THE DRAWING

FIG. 1. REPRESENT DOUBLE COMBINED INTEGRATED THERMAL AND PHOTO VOLTAIC SOLAR ENERGY SYSTEMS

FIG. 2 UNIVERSAL CROSS HYPERBARIC THERMAL ELECTRIC STEAM ENGINE

FIG. 3 Detail enlarged of the group of thermal steam cylinder, associated with linear electric generator

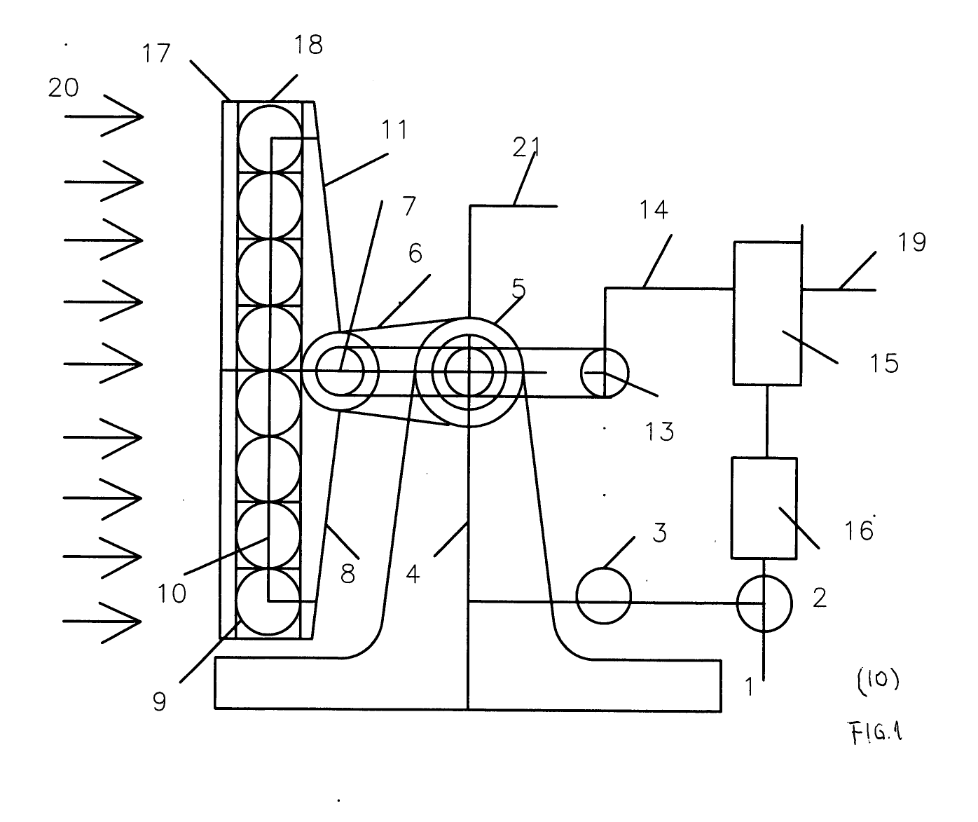

In the FIG. 1, indicated by generic number (10) is indicated the Double integrated Thermal and Combined Thermal and Photo voltaic Solar Energy Systems. Composed and functional activated by a source of refrigeration fluid 1, stored in the reservoir 2 and pressurized by the high pressure hydraulic pump 3, introducing the high refrigeration fluid in the body of the general support 4 from which the fluid is conducted in the articulation center 5, and by the arm 6 and articulation 7 is conducted by channel 8 in the thermal panel 9, conformed by an assembled tubular heat exchanger 9 and 10, which is collecting all the thermal energy transformed in high temperature and pressure steam conducted by the channel 11 in a parallel articulation 7, back in parallel arm, and collector 6, to the collector 12, 13, and 14 to supply the high pressure steam in the cross hyperbaric steam thermal electric engine 15. And after total expansion is conducted in the condenser 16, and the refrigeration fluid is returned in the reservoir 2, from which is reintroduce in the energy cycle.

The photo voltaic foil 17 is intimate connected the surface of individual photovoltaic cells to the surface of the thermal panel 18. Forming a common body receiving and collecting the 100% energy received from the solar radiation 20 transformed in electricity 19 AC, and DC supplied by 21 to the users.

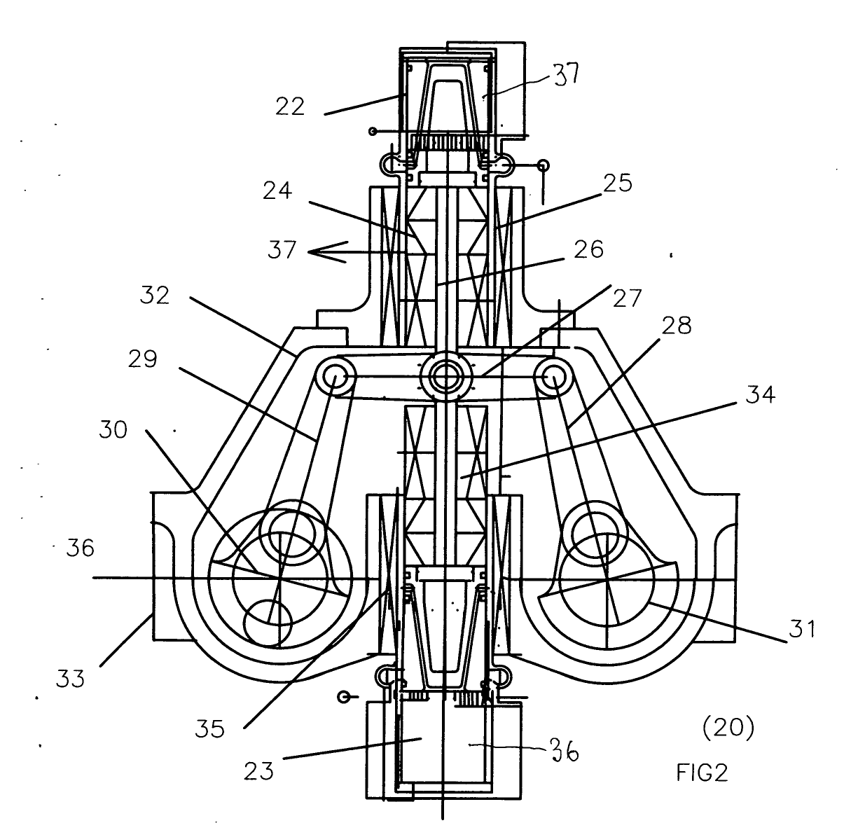

In the FIG. 2 is indicated by the generic number (20) Universal Cross Hyperbaric Thermal Electric Steam and universal combustion engine, a derivative SOLAR and STEAM functional alternative of<<<Universal cross hyperbaric, hybrid thermal electric engine, compressor, expander and universal mobility systems>>>, patent application Ser. No. 13/815,971, filling date Mar. 18, 2013, US PATENT CONFIRMATION NO 2561/05/20 2013.

This thermal electric steam cross hyperbaric engine is composed primary from two thermal steam symmetric opposed two cylinder 22 and 23, connected each with two opposed linear alternative moving permanent magnet inducers 24 and 34, included in the two opposed coils electric generators 25 and 35.

Both opposed thermal cylinders are provided with thermal pistons 36 and 37 interconnected by central bar 26 articulated with the cross bar 27, and symmetric articulated with two symmetric connecting rods 28 and 29, driving counter rotating two crankshafts 30 and 31, forming a permanent absolute echilibrium dynamic systems for balancing all the linear and rotary inertial forces and all momentums.

The symmetric opposed connecting rods 28 and 29 are eliminating 100% all the side forces between the pistons and cylinders,<<<real flying pistons >>>with virtual zero friction and maximum mechanical efficiency, making all the mechanism a real perfection.

The opposed rotating crankshafts 30 and 31 are geared symmetric one/one by outside gear box not indicated in the FIG. 2.

Each thermal steam cylinder is transferring directly the thermal energy to the linear electric generators, in parallel with continuous counter rotating electric generators, resulting a perfect direct total transformation, of all thermal steam energy in electric AC current energy with maximum absolute efficiency.

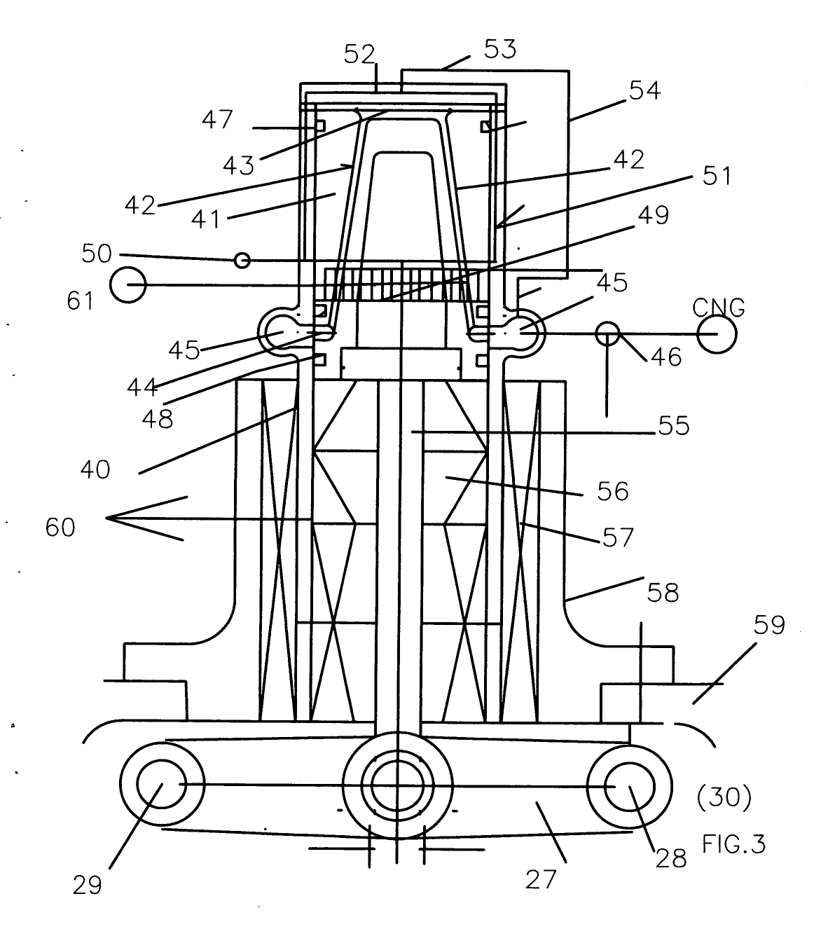

In the FIG. 3 Indicated by the generic number (30) is representing the central cross hyperbaric thermal electric linear generator, composed from the steam thermal engine cylinder 40 containing the thermal piston 41 provided with multiple connecting channels 42, with the top piston chamber 43, connected with the circular piston belt chamber 44, in coincidence moment with circular cylinder belt chamber 45. In which is injected the steam energy from the external source 46, or any alternative fuels combustion like CNG, LNG, or any other available fuels.

The refrigeration cooling fluid of the cylinder walls is supplied by the high pressure source 50 and is invading all the cooling channels in the cylinders wall 51 until the top cylinder head 52, from which all the collected cooling energy is exit by the cannel 53, 54, and injected in the belt circular chamber 45, to be associated and in common expansion with the main steam energy flow 46 provided by all sources of steam high pressure provided by the energy system.

All the thermal energy collected and provided in the engine cylinder is starting to pressurize the chamber 43 pushing the piston 41 in the expansion stroke until the connection of circular piston belt 44 is in connection with circular cylinder circular belt chamber 45, producing a common power expansion.

After the connection of the piston circular belt 44 belt is separated from the circular cylinder belt 45, the rest of expansion is in continuation only in the cylinder working volume, and a portion of the partial expanded steam is retain in the separated cylinder circular belt 45, until the next cycle and next expansion.

The expanded steam is finally evacuated outside of cylinder by the exhaust ports 49 and returned to the condenser 16, and the liquid refrigeration fluid is returned for continuation of the total energy thermal steam cycle.

In the back up time the alternative fuels CNG, LNG, Hydrogen and all available fuels combustion are supported by pressurized oxygen injection by the 61 source acting in the scavenging time replacing the exhaust steam by exhaust combusted gases, diverted from the condenser 16.

All the thermal energy produced is transferred directly to the linear permanent magnet inducer 55, 56, and transformed in alternative current by the coil 57, and the final residual energy is transferred by the axial rod 55 to the cross bar 27 which is activating the symmetric opposed acting connecting rods 28 and 29, driving the counter rotating crankshaft of the engine and the counter rotating rotary electric generators, indicated in the FIG. 2

The assembled central tower 58 containing the coil 57, is the connecting body 59 of the engine indicate in the FIG. 2.

The total eternal integrated of all thermal energies, associated with solar photo voltaic, and infinite atmospheric thermal energy, combined with geo thermal eternal energy, and universal alternative fuels capability, is the culmination of the eternal salvation of humanity with green zero emission unlimited world prosperity.

What is claimed:

1. The total eternal synergetic cooperation and association and integration of all eternal energies transforming directly in green electric energy of the solar, wind, thermal atmospheric, geo thermal, and alternative nuclear, which have individual specific limitations, are compensated and harmonized by the universal unlimited energy, including back up, by universal fuel combustion capability of the universal cross thermal electric hyperbaric engine assistance, to compensate all variable, reduced incidental environment capacities, which is making entire energy system full reliable with 100% readiness capability, and maximum absolute efficiency.

2. The solar eternal total energy capability, of the claim one, is created by the associated full capacity of the photo voltaic panel connected superimposed intimately with the basic thermal energy panel systems, forming a double green integrated electric energy system, for direct transformation of entire solar energy in electric energy, with and by the cooperation of the universal cross hyperbaric thermal electric engine, having universal fuel combustion alternative capability to compensate the variable incidental reduced capacity of the solar, wind, energy systems, producing a total constant energetic capability.

3. The atmospheric and solar eternal infinite energy, from the claim one, is captured and producing a direct transformation in electric energy by the refrigeration effect for absorbing thermal atmospheric energy by the thermal energy panel producing high temperature and pressure steam storage of thermal energy working fluid, to be expanded in the universal cross hyperbaric thermal electric engine, in a closed thermal Carnot cycle with near 100% efficiency.

4. The geo thermal infinite and eternal energy from claim one, is available over the entire planet to produce high pressure and high temperature steam energy to be used storaged and transformed directly in electric energy by the universal cross hyperbaric thermal electric steam engine individually or combined with solar and atmospheric integrated energy systems, for eternal prosperity of eternal life of humanity.

5. This invention of all these claims, can convert and use associated eternal wind energy producing DC current with specific the variability and intensity in parallel with solar energy, atmospheric energy, geo thermal energy, to electrolyze the water, producing and storing cryogenic eternal hydrogen and oxygen for combustion and steam generation in the universal cross hyperbaric thermal electric engine for total synergetic of all eternal energies, including alternative nuclear available on our planet.

6. The general directly eternal electric energy generation, of all claims, and transformation of all eternal energies in electric energies, capable to electrolyze the salt ocean or any waters, will result Oxygen and Hydrogen universal fuel, and eternal capability for desalination of water, in combination with eternal energy production, and unlimited eternal and universal water availability for agriculture irrigation, of entire planet,
